(19) United States
(12) Patent Application Publication
(10) Pub. No.: US 2014/0017972 A1
(43) Pub. Date: Jan. 16, 2014

(54) HOOP WITH INLAID PATTERN

(71) Applicant: Brian KESSLER, Los Angeles, CA (US)

(72) Inventor: Brian KESSLER, Los Angeles, CA (US)

(73) Assignee: MAUI TOYS, INC, Los Angeles, CA (US)

(21) Appl. No.: 13/545,586

(22) Filed: Jul. 10, 2012

(51) Int. Cl. A63B 19/00; F16L 9/133

(52) U.S. Cl. 446/236; 138/140

(57) ABSTRACT

A hoop for play and/or exercise is formed of plural layers of plastic of different colors, with openings in the upper layer permitting the colored underlayer to show through the openings.

### FIELD OF INVENTION

The present invention relates to hoops of the “hula hoop” type, which hoops are formed from a tube containing colorful lines and/or other patterns which are dimensionally imbedded into the body of the tube.

### BACKGROUND

Hoops for play and exercise are often given colorful, decorative components, such colorful features being provided by exterior applied tape or wrapping of various types applied to the exterior of the tubular member forming the hoop. Hoops of different colors have also been made from colored plastic tubing, but in such cases the tubing itself is of a uniform color. Multicolored hoops having the colors applied to the surface, such as by colorful adhesive tapes, paints or the like, are subject to loss of color through simple use, wherein the coloring wears from or is rubbed off the surface. Hoops of a single color made from colored plastic tubing are limited to a single color.

### SUMMARY OF INVENTION

It would be useful to have hoops of multicolors wherein the colors are part of the plastic tubing from which the hoops are formed. This is achieved according to the present invention by extruding two or more streams, preferably layers, of different colored plastics together, and then partially removing one or more upper layers in a pattern to reveal one or more lower layers of a different color, and providing a three-dimensional surface of the plastic tubing to be formed into a hoop.

### BRIEF DESCRIPTION OF DRAWING

FIG. 1 is photographic reproduction of a first plastic tubing according to the present invention.

FIG. 2 is a photographic reproduction of portions of four hoops formed of tubings in accordance with the present invention, each tubing comprising a bottom layer of a first color and a top layer of a second color, and wherein parts of the top layer have been removed in a zigzag pattern revealing the bottom layer of color.

FIG. 3 is a perspective view of an apparatus illustrating a method for forming tubing for hoops as shown in FIG. 2.

### DETAILED DESCRIPTION OF EMBODIMENTS

Modern hoops are formed of tubular plastic, usually cylindrical, which are subsequently curved to form a circular hoop shape with the two ends joined to form the hoop. Hoops in accordance with the present invention may be and preferably are formed in this way, with the present invention residing in the appearance of the tubular plastic material, its physical structure, and its method of manufacture.

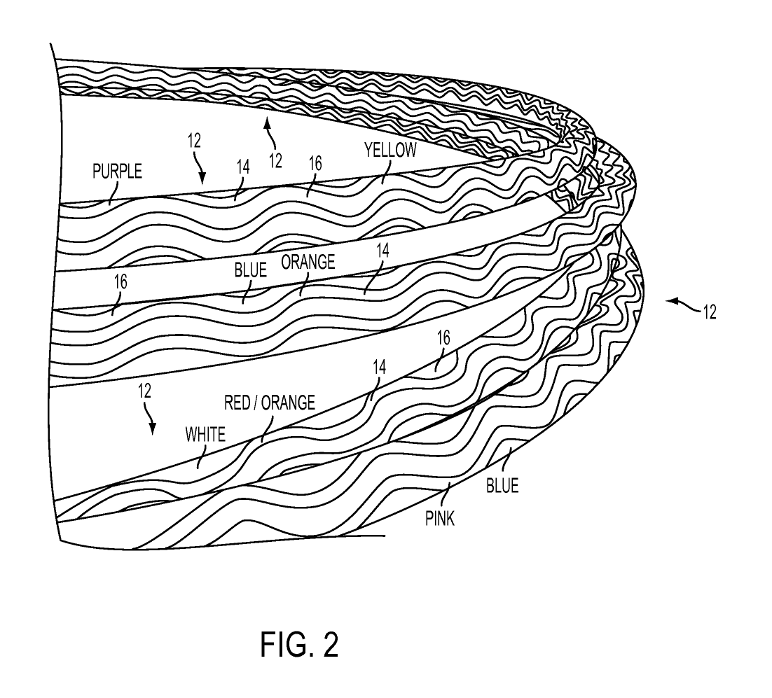

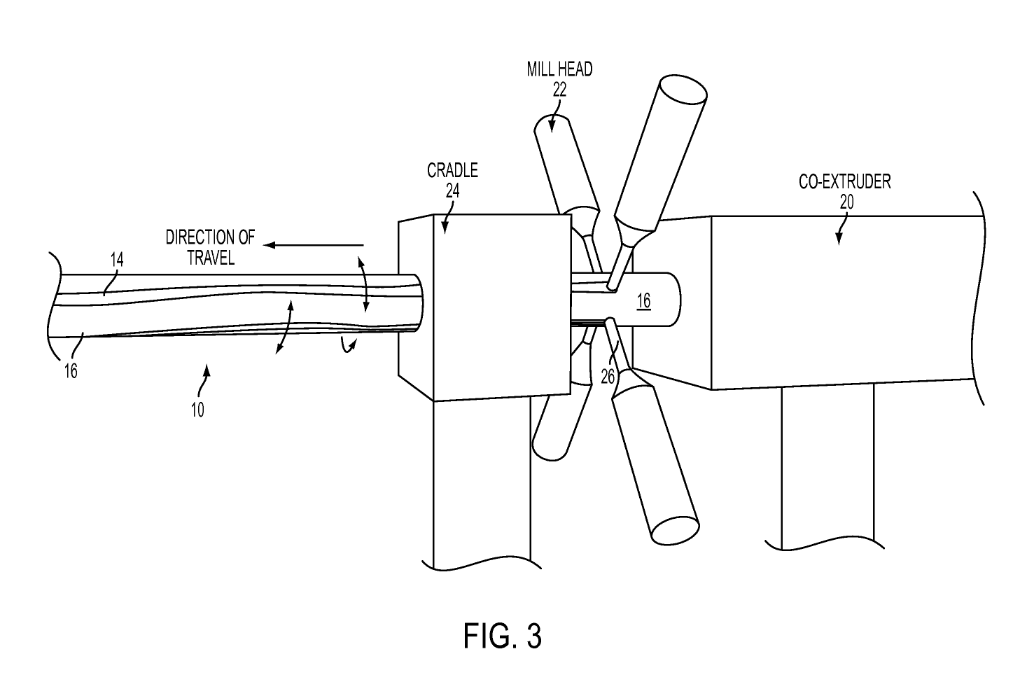

As best shown in FIG. 2, the body of each tube 10 (see FIG. 3) formed into a hoop 12, contains a colorful pattern, e.g. squiggle lines of a generally sinusoidal configuration in the embodiments of FIG. 2, which are dimensionally embedded as part of the structure of the tube, not simply painted on or adhered to the surface of the tube. In the embodiments of FIG. 2, the tube from which the hoops 12 are formed comprises an inner layer of plastic 14 and an outer plastic layer 16 of a color different from the color of the inner layer 14.

It is desirable that the overall thickness of the wall of each tube 10 be approximately the same as the conventional thickness of such tubing walls so as to keep the overall weight of the resultant hoop 12 from becoming too heavy. On the other hand, depending on the colors, in some cases it may be desirable to make the outer layer 16 somewhat thicker than the inner layer 14 to prevent the color of the bottom layer 14 from showing through the upper layer 16. Otherwise, the two layers 14 and 16 should be of approximately the same thickness. The overall wall thickness of the tube 10 should be about 0.050 inches, plus or minus 0.020 inches, thus providing a tube wall thickness of 0.070-0.030 inches, with each layer 14 and 16 of a two layer tube having a thickness on the order of 0.018 inches, plus or minus 0.010-0.020 inches.

The exterior dimensions of hoops 12 in accordance with the present invention are consistent with those commonly known and used. For example, the tubes 10 of such hoops 12 may have an exterior diameter of 0.5 inches, plus or minus 0.25 inches. The diameters of the hoops may vary widely, e.g. from 25 to 38 inches.

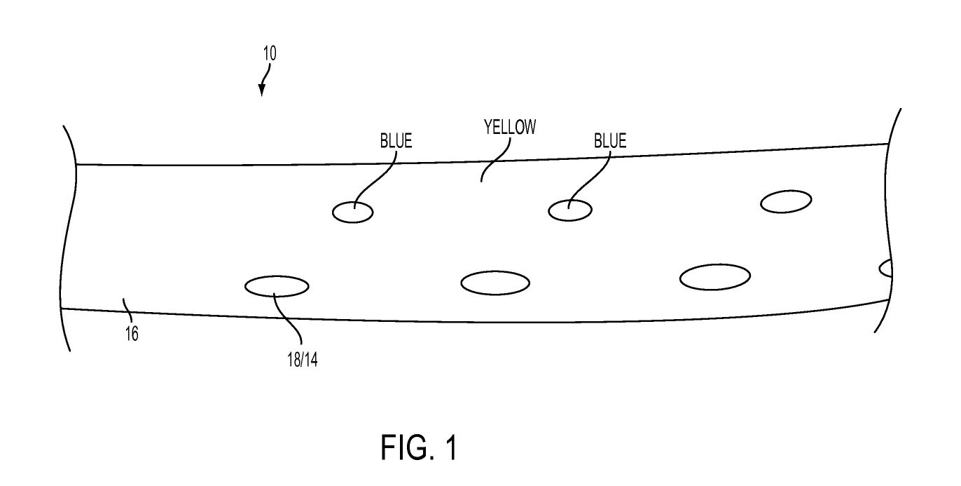

The plastic materials from which the tubing 10 of the present invention may be formed can be selected from those which are conventionally used for hoops, such as those disclosed in my earlier patents, include U.S. Pat. No. 6,494,760; U.S. Pat. No. 6,482,136; and U.S. Pat. No. 7,959,485, which are respectfully incorporated by reference. Thus, for two layered tubes 10, including those of FIGS. 1 and 2, such tubes 10 are extruded in two layers, i.e. the two layers are co-extruded from a co-extruder 20 as shown in FIG. 3 from separate differently colored batches of polyethylene or polyethylene terephthalate.

Upon emerging from the die of the co-extruder 20, the tubing 10, preferably while still hot and relatively easily worked, is subjected to a process which removes portions of the top layer 16. This is schematically illustrated in FIG. 3 by a mill head device 22 comprising device 26 which scrape (or cut) away parts of the upper layer 16 revealing therebeneath the under layer 14. The tubing 10 then continuously passes on to a cradle device 24 which rotates the still hot and malleable plastic, thereby obtaining a squiggle pattern. The cradle 24 also serves the purpose of maintaining consistency by keeping the still hot tube from movement in the axial direction, and minimizing the effects of any vibration.

While FIG. 2 shows some possibilities of different color combinations in the squiggle pattern, it will be understood that other colors and other patterns can be provided. In place of solid colors, one of the layers can be translucent or even transparent. Other patterns, including the pattern of the tube 10 shown in FIG. 1, can be similarly made.

By using the removal method shown in FIG. 3, a great variety of zigzagging patterns can be achieved by regulating the speed of the line feed, as well as the amount of rotation provided, the width of the removal devices 26 of the mill head 22, and the number of removal devices 26.

Tubing in accordance with the present invention can be made without the rotation which provides the squiggle lines, wherein tubing with straight lines can be made. FIG. 1 shows another option involving devices 26 of the mill head which axially reciprocate toward and away from the tubing, this providing cavities 18 exposing the layer 14 beneath the layer 16.

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications, including patterns other than shown in FIGS. 1 and 2, should and are intended to be comprehended within the meaning and range of equivalents of the disclosed embodiments. It is to be understood that the phraseology or terminology employed herein is for the purpose of description and not of limitation. The means, materials, and steps for carrying out various disclosed functions may take a variety of alternative forms without departing from the invention.

Thus the expressions “means to . . . ” and “means for . . . ”, or any method step language, as may be found in the specification above and/or in the claims below, followed by a functional statement, are intended to define and cover whatever structural, physical, chemical or electrical element or structure, or whatever method step, which may now or in the future exist which carries out the recited function, whether or not precisely equivalent to the embodiment or embodiments disclosed in the specification above, i.e., other means or steps for carrying out the same functions can be used; and it is intended that such expressions be given their broadest interpretation.

What is claimed is:

1. A plastic tube comprising a co-extrudate from a coextruder of a first exterior layer and a second interior layer, the exterior layer comprising a first color and the interior layer comprising a second color, the exterior layer having depressions or openings therein through which the color of the second layer are exposed.

2. The tube of claim 1, wherein the tube is cylindrical, the exterior layer encircles the interior layer, and the openings in the exterior layer through which the interior layer can be seen are in a form of squiggle lines of a generally sinusoidal configuration.

3. The tube of claim 1 shaped into the form of a hoop.

4. The tube shaped in the form of a hoop of claim 3, wherein said tube is cylindrical and has an exterior diameter of 0.5 inches, plus or minus 0.25 inches.

5. The tube of claim 1, comprising co-extruded layers, wherein portions of the exterior layer have been continuously removed downstream of the coextruder.

6. The tube shaped in the form of a hoop of claim 4, wherein portions of the exterior layer have been continuously removed downstream of the coextruder.
